(19) United States
(12) Patent Application Publication
(10) Pub. No.: US 2025/0037006 A1
(43) Pub. Date: Jan. 30, 2025

(54) INSTANCE RECOMMENDATIONS FOR MACHINE LEARNING WORKLOADS

(71) Applicant: ADOBE INC., San Jose, CA (US)

(72) Inventors: Kanak MAHADIK, San Jose, CA (US); Sungchul KIM, San Jose, CA (US); Ryan ROSSI, San Jose, CA (US); Handong ZHAO, San Jose, CA (US); Shravika MITTAL, Atlanta, GA (US)

(21) Appl. No.: 18/225,970

(22) Filed: Jul. 25, 2023

(51) Int. Cl. G06N 20/00

(52) U.S. Cl. CPC G06N 20/00

(57) ABSTRACT

In various examples, a ranking is generated for a set of computing instances based on predicted metrics associated with computing instances. For example, a prediction model estimates various system performance metrics based on information associated with a workload and configuration information associated with computing instances. The system performance metrics estimated by the prediction model are used to rank the set of computing instances.

### BACKGROUND

Various types of artificial intelligence (AI) models can be trained using various training techniques. In addition, cloud computing services are frequently relied on during training of AI models. For example, cloud computing services provide access to a large number of computing instances with various configurations that can be used in a plurality of applications including AI models. In addition, as the size and complexity of AI models grow, so too does the number of different types of computing instances offered by the computing resource service providers.

### SUMMARY

Embodiments described herein generally relate to a workload-agnostic prediction machine learning model which predicts epoch training time, processing time, processor utilization, and/or other attributes for any combination of computing instance configuration and/or AI model workload. In accordance with some aspects, the systems and methods described are directed to training a prediction machine learning model that is capable of predicting various outcomes and/or attributes of executing a workload (e.g., training a machine learning model, performing inferencing using the machine learning model, pre-training tasks, etc.) using a computing instance. In addition, in various examples, the prediction machine learning model is capable of generating predictions for new or otherwise unseen machine learning workloads and/or computing instances. For example, for workloads and/or computing instances that are new (e.g., not included in the training data), the prediction machine learning model can predict the system performance features and use the predicted system performance features to predict the epoch training time and processor utilization for the new workloads and/or computing instances.

Furthermore, in various examples, the prediction machine learning model is used to generate recommendations for computing instance types and/or configurations to maximize and/or minimize a metric when executing the workload. In one example, the prediction machine learning model is included in an instance recommendation tool that allows a user to minimize an amount of training time needed to train an AI model. Continuing the example, the user can select one or more metrics to maximize and/or minimize and the instance recommendation tool, using the prediction machine learning model, can rank computing instances based on the results of the prediction machine learning model. For instance, the user can maximize processor utilization, minimize training cost, minimize training time, and/or a combination of these metrics using the instance recommendation tool.

### BRIEF DESCRIPTION OF THE DRAWINGS

The present invention is described in detail below with reference to the attached drawing figures, wherein:

FIG. 1 depicts an environment in which one or more embodiments of the present disclosure can be practiced.

FIG. 2 depicts an environment in which computing instances are ranked based on metrics predicted by a prediction model, in accordance with at least one embodiment.

FIG. 3 depicts an environment in which computing instances are ranked based on metrics predicted by a prediction model, in accordance with at least one embodiment.

FIG. 4 depicts an example process flow for ranking computing instances based on metrics predicted by a prediction model, in accordance with at least one embodiment.

FIG. 5 depicts an example process flow for training a prediction model to predict metrics for a computing instance processing a workload, in accordance with at least one embodiment.

FIG. 6 depicts an example process flow for generating a training dataset to train a prediction model, in accordance with at least one embodiment.

FIG. 7 is a block diagram of an exemplary computing environment suitable for use in implementations of the present disclosure.

### DETAILED DESCRIPTION

Embodiments described herein generally relate to a prediction machine learning model which predicts processing time, processor utilization, and/or other metrics for any combination of computing instance type, computing instance configuration, workload, and/or machine learning model. In one example, the prediction model predicts a set of system performance features which include various metrics such as processor utilization, memory utilization, training time, or other metrics indicating performance of a computing instance during performance of a workload. In accordance with some aspects, the systems and methods described are directed to training the prediction model which is capable of predicting various outcomes and/or metrics of executing various machine learning workloads (e.g., training a machine learning model, performing inferencing using the machine learning model, pre-training tasks, etc.) using a computing instance. In addition, in various embodiments, the prediction model is capable of generating predictions for new or otherwise unseen machine learning workloads and/or computing instances. For example, the prediction model is capable of generating predictions for computing instances, instance configurations, workloads, and/or machine learning models that are not included in the training dataset used to train the prediction model (e.g., unseen relative to the prediction model).

Furthermore, in various embodiments, the prediction model is used to generate recommendations for computing instance types and/or configurations to maximize and/or minimize an attribute of executing the workload. In one example, the prediction model is included in an instance recommendation tool that allows a user to minimize an amount of training time needed to train a machine learning model. Continuing the example, the user can select one or more metrics to maximize and/or minimize and the instance recommendation tool, using the prediction model, can rank types of computing instances based on the results of the prediction model. For instance, the user can maximize processor utilization, minimize training cost, minimize training time, and/or a combination of these metrics using the instance recommendation tool.

In an embodiment, computing resource service providers (e.g., cloud computing services) provide access to a variety of different computing instances and computing instance configurations. For example, when creating the computing instance, the user can select from a number of different types of processors including graphics processors accessible to the computing instance. In various embodiments, the computing resource service provider allows the user to select various configurations of the computing instance including the number of central processing units (CPUs), the type of CPU, the number of graphics processing units (GPUs), the type of GPU, a type of CPU memory, an amount of CPU memory, a type of GPU memory, an amount of GPU memory, or other aspects of the computing instance. However, different computing instance configurations, for example, have different performance metrics when executing the same workload. In addition, computing instances with access to more computing resources, in some examples, do not perform better than computing instances with access to less computing resources. As a result, in such examples, selecting an optimum computing instance configuration for various workloads can be difficult and time consuming for users. In addition, other solutions are unable to provide recommendations for computing instances, workloads, and/or machine learning models that are previously unseen.

Furthermore, in various embodiments, the instance recommendation tool allows the user to balance training time and performance metrics for different workloads and/or computing instances (e.g., different instance configurations offered by the computing resource service provider). For example, the instance recommendation tool can rank computing instances based on the highest average processor utilization and the lowest epoch training time. In various embodiments, the prediction model includes three models, a first model to predict system performance features (e.g., metrics associated with a computing instance given the instance configuration and the workload), a second model to predict an amount of time to process the workload (e.g., an epoch training time), and a third model to predict utilization of the computing instance (e.g., processor utilization, memory utilization, etc.).

During training, in an embodiment, the prediction model (e.g., the three models above) is trained using benchmark data collected from a plurality of computing instances executing a plurality of workloads. In one example, the training dataset includes various feature classes including instance features, model features, and system performance features. In various embodiments, the features include parameters, attributes, metrics, and/or other data obtained from the workload and/or computing instances. For example, the instance features include parameters of the computing instance configurations such as CPU type, GPU type, memory, and/or other parameters of the computing instance. In another example, the model features include the number of layers, number of activations, model parameters, batch size, or other attributes of the workload. In yet another example, the system performance features include various benchmarks obtained from computing instances when executing various workloads such as processor utilization.

In an embodiment, the prediction model takes as an input a workload and plurality of computing instances and predicts the system performance features for the plurality of computing instances given the workload. Furthermore, in various embodiments, when the user provides a previously unseen workload and/or computing instance as an input to the instance recommendation tool, the prediction model performs a forward pass and predicts the system performance features which are then used to predict the epoch time and the processor utilization. Returning to the example above, the first model predicts the system performance features which are passed to the second model and the third model (e.g., appended to the feature vectors provided as an input to the second model and the third model).

Aspects of the technology described herein provide a number of improvements over existing technologies. For example, existing solutions are unable to provide recommendations for a workload that was not included in the dataset used to train the existing solution. Furthermore, in some instances, such datasets are not available and are difficult to generate. For example, existing technology is workload dependent and must be trained using data from a particular computing instance with a particular configuration executing a particular workload using a particular machine learning model in order to generate predictions for such a combination. Furthermore, such technologies are only capable of reducing training time and do not generate predictions for other metrics associated with executing the workload (e.g., processor utilization, memory utilization, core temperature, etc.). As such, the prediction model provides an improvement over existing technologies by enabling users to generate recommendations for any combination of computing instances and/or workloads regardless of the dataset used to train the prediction model (e.g., the data collected from the computing instance and/or workload). Furthermore, the instance recommendation tool and prediction model allow the user to optimize a plurality of different attributes, not simply reduce the training time for executing the workload.

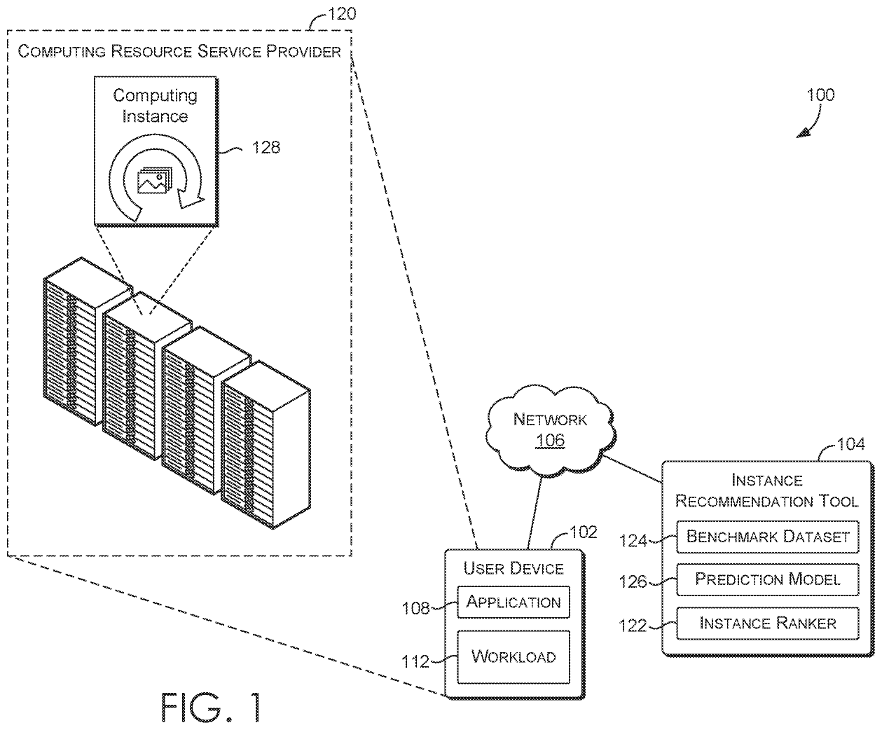

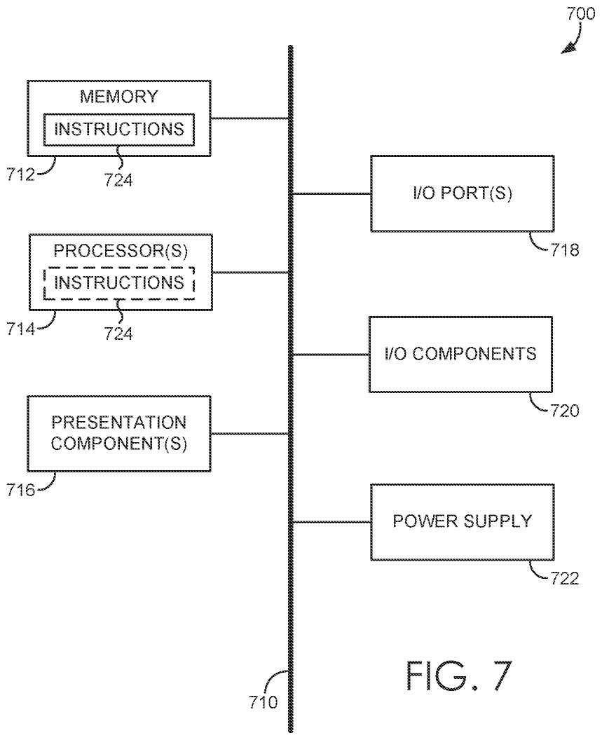

Turning to FIG. 1, FIG. 1 is a diagram of an operating environment 100 in which one or more embodiments of the present disclosure can be practiced. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory as further described with reference to FIG. 7.

It should be understood that operating environment 100 shown in FIG. 1 is an example of one suitable operating environment. Among other components not shown, operating environment 100 includes a user device 102, instance recommendation tool 104, and a network 106. Each of the components shown in FIG. 1 can be implemented via any type of computing device, such as one or more computing devices 700 described in connection with FIG. 7, for example. These components can communicate with each other via network 106, which can be wired, wireless, or both. Network 106 can include multiple networks, or a network of networks, but is shown in simple form so as not to obscure aspects of the present disclosure. By way of example, network 106 can include one or more wide area networks (WANs), one or more local area networks (LANs), one or more public networks such as the Internet, and/or one or more private networks. Where network 106 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 106 is not described in significant detail.

It should be understood that any number of devices, servers, and other components can be employed within operating environment 100 within the scope of the present disclosure. Each can comprise a single device or multiple devices cooperating in a distributed environment. For example, the instance recommendation tool 104 includes multiple server computer systems cooperating in a distributed environment to perform the operations described in the present disclosure.

User device 102 can be any type of computing device capable of being operated by an entity (e.g., individual or organization) and obtains data from instance recommendation tool 104 and/or a data store which can be facilitated by the instance recommendation tool 104 (e.g., a server operating as a frontend for the data store). The user device 102, in various embodiments, has access to or otherwise maintains a workload 112 which includes various types of workloads that can be executed by a computing instance 128 or other computing device using a machine learning model. For example, the application 108 includes a machine learning model (e.g., deep learning model, regression model, neural network, etc.) that can be executed by the computing instance 128 of a computing resource service provider 120 to perform and/or process the workload 112. In various embodiments, the workload 112 includes a training task for the machine learning model of the application 108. In yet other embodiments, the workload 112 includes an inferencing task of the machine learning model of the application 108.

In some implementations, user device 102 is the type of computing device described in connection with FIG. 7. By way of example and not limitation, the user device 102 can be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors, and one or more computer-readable media. The computer-readable media can also include computer-readable instructions executable by the one or more processors. In an embodiment, the instructions are embodied by one or more applications, such as application 108 shown in FIG. 1. Application 108 is referred to as a single application for simplicity, but its functionality can be embodied by one or more applications in practice. In some embodiments, the user device 102 includes the computing instance 128 (e.g., virtual machine) executed by computing resources (e.g., server computer systems) provided by a computing resource service provider 120. In one example, the computing resource service provider 120 provides users with access to services such as a virtual computing service to enable the user to execute the application 108 using computing instances provided by the computing resource service provider 120. Furthermore, in various embodiments, the computing resource service provider 120 offers a plurality of different computing instance configurations. In one example, the user can select between different configurations of computing instances including the number and type of processors, size and type of memory, storage, network type, system architecture, operation system, accessible devices, or any other configuration information for the computing instance 128.

In various embodiments, the application 108 includes any application capable of facilitating the exchange of information between the user device 102 and the instance recommendation tool 104. For example, the application 108 provides the instance recommendation tool 104 with information associated with the workload 112 and/or computing instances available to execute the application 108 and the instance recommendation tool 104 returns a ranking of the computing instances based on one or more metrics selected by a user. In some implementations, the application 108 comprises a web application, which can run in a web browser, and can be hosted at least partially on the server-side of the operating environment 100. In addition, or instead, the application 108 can comprise a dedicated application, such as an application being supported by the user device 102 and computing resources of the computing resource service provider 120. In some cases, the application 108 is integrated into the operating system (e.g., as a service). It is therefore contemplated herein that “application” be interpreted broadly. Some example applications include ADOBE® SIGN, a cloud-based e-signature service, and ADOBE ACROBAT®, which allows users to view, create, manipulate, print, and manage documents.

For cloud-based implementations, for example, the application 108 is utilized to interface with the functionality implemented by the instance recommendation tool 104. In some embodiments, the components, or portions thereof, of the instance recommendation tool 104 are implemented on the user device 102 or other systems or devices. Thus, it should be appreciated that the instance recommendation tool 104, in some embodiments, is provided via multiple devices arranged in a distributed environment that collectively provide the functionality described herein. Additionally, other components not shown can also be included within the distributed environment. Furthermore, while the examples described in connection with FIG. 1 describe computing instances (e.g., virtual machines) provided by the computing resource service provider 120, the instance recommendation tool 104, in various embodiments, provides rankings of various types of computing devices such as on-premises server computers, personal computers, laptops, or any other computing device suitable for executing the application 108.

As illustrated in FIG. 1, the instance recommendation tool 104 provides the user with a ranking and/or recommendation for the computing instance 128 to execute the application 108 to process the workload 112. In one example, the workload 112 includes a batch of images to train a neural network. In another example, the workload 112 includes an audio file to convert into a transcript using a natural language processor. In various embodiments, the workload 112 includes training and/or inferencing to be performed by a machine learning model of the application 108.

In various embodiments, the computing instance 128 includes a GPU which can include various different GPU architectures. Furthermore, in such embodiments, the computing instance 128 is capable of being configured with different numbers of GPUs, different virtual CPUs, different numbers of virtual CPUs, network bandwidth, and other configurations. The different possible configurations of the computing instance 128, for example, produce different efficiency metrics when executing the application 108. In addition, in such examples, some configurations to the computing instance 128 include unseen configurations such as new configurations of hardware, software, and/or other configurations for which metrics including efficiency metrics when executing the application 108 are unavailable. In various embodiments, the instance recommendation tool 104 predicts various system performance metrics for the unseen configurations in order to generate the ranking and/or the recommendation associated with the unseen configurations.

Similarly, in an embodiment, the workload 112 includes different representations, different model architectures, and/or hardware requirements, some of which include unseen workloads (e.g., workloads for which the instance recommendation tool 104 does not have data). For example, new machine learning models can include different numbers of layers, activations, parameters, or other architectures that the instance recommendation tool 104 does not have data associated with. In various embodiments, the instance recommendation tool 104 includes a benchmark dataset 124 which is used to train a prediction model 126. In such embodiments, the prediction model 126 generates predicted metrics for the computing instance 128 when executing or otherwise processing the workload 112 (e.g., using the application 108) which is used by an instance ranker 122 to generate the ranking or otherwise recommending the computing instance 128.

The benchmark dataset 124, in an embodiment, includes metrics such as system performance metrics obtained from a plurality of different configurations of computing instances during execution of a plurality of different workloads. For example, different configurations of computing instances (e.g., processor architecture, number of processors, memory, etc.) are used to execute different workloads (e.g., training of transformers, neural networks, regression models, etc.) and the instance recommendation tool 104 obtains metrics generated during execution such as processor utilization, memory utilization, core temperature, epoch training time, or any other metric collected from a computing instance (e.g., including statistical data such as average, mean, mode, maximum, minimum, etc.). Continuing this example, the metrics collected are profiled and stored in the benchmark dataset 124.

In various embodiments, the prediction model 126 is trained using the benchmark dataset 124 to predict various system performance metrics of the computing instance 128 when executing the workload 112. For example, the prediction model 126 predicts the epoch training time, epoch training cost, average processor utilization, average memory utilization, or other metrics. In various embodiments, the prediction model 126 includes a regression model, a transformer, a neural network, or other any other machine learning model capable of predicting system performance metrics. In one example, during inferencing, the prediction model 126 takes as an input the computing instance 128 (e.g., a set of possible configurations of the computing instance) and the workload 112 (e.g., number of layers, number of activations, floating point operations, model parameters, batch size, etc.) and outputs the epoch training time (c) and average GPU utilization (u_{G}) for the workload 112 (w_{T}) on the set of possible computing instances. In other examples where the benchmark dataset 124 does not include data associated with the computing instance 128 or the workload 112, during inferencing, the prediction model 126 generates system performance metrics for the computing instance 128 and uses the generated system performance metrics to predict the epoch training time (c) and average GPU utilization (u_{G}).

In various embodiments, the prediction model 126 includes three models M₁, M₂, and M₃, where M₁ outputs system performance metrics for the workload 112 w_{T}, M₂ outputs the epoch training time c, and M₃ outputs the average GPU utilization u_{G}. In one example, the model M₁ is trained, using the benchmark dataset 124 (X), to output system performance metrics for the workload 112 w_{T}_{_{system performance}} given by the following equation: M₁(X, w_{T}_{_{GPU, model}}) w_{T}_{_{system performance}}, where w_{T}_{_{GPU,Model}} includes a feature vector of class features for the workload 112 and the computing instance 128. Continuing this example, the system performance metrics outputted by M₁ are then appended to the workload 112 (e.g., the feature vector w_{T} including class features for the workload 112 and the computing instance 128) w_{T}_{_{GPU, model, system performance}} and used to train M₂ and M₃ given by the following equations:

$${M}_{2} ( X , {w}_{{T}_{GPU , model , system performance}} ) \to c$$

$${M}_{1} ( X , {w}_{{T}_{GPU , model , system performance}} ) \to {u}_{G}$$

In various embodiments, the class features associated with the computing instance 128 include number of GPUs, GPU memory, GPU type, number of CPUs, and CPU memory. In addition, in such embodiments, the class features associated with the machine learning model (e.g., the model processing the workload 112) include number of layers, number of activations, floating point operations, model parameters, and batch size. Furthermore, in some embodiments, the class features associated with the system performance metrics include CPU utilization, GPU utilization, and memory utilization. In some examples, additional or fewer class features can be used by the prediction model 126.

In various embodiments, the instance ranker 122 utilizes the system performance metric (e.g., the output of the prediction model) to rank (e.g., recommend) computing instances for processing the workload 112. For example, the user can indicate a specific goal or use case and the instance ranker 112 generates a ranking of the computing instances (e.g., possible configurations of the computing instance 128) based on the specific goal or use case. In various embodiments, the instance ranker 122 ranks the computing instances based on the metrics outputted by the prediction model or a combination of metrics. For example, users might prefer the computing instance with higher average GPU utilization and low epoch training time.

In various embodiments, the instance recommendation tool 104 provides the user with various ranking scenarios. In one example, the instance ranker 122 recommends and/or ranks the computing instance 128 with the highest average GPU utilization. In another example, the instance ranker 122 recommends and/or ranks the computing instance 128 with the lowest epoch training time. In another example, the instance ranker 122 recommends and/or ranks the computing instance 128 with the lowest epoch training cost (e.g., the epoch training time multiplied by the cost of operating the computing instance 128). In yet another example, the instance ranker 122 recommends and/or ranks the computing instance 128 which achieves the best utilization to cost ratio (e.g., average GPU utilization divided by the epoch training cost).

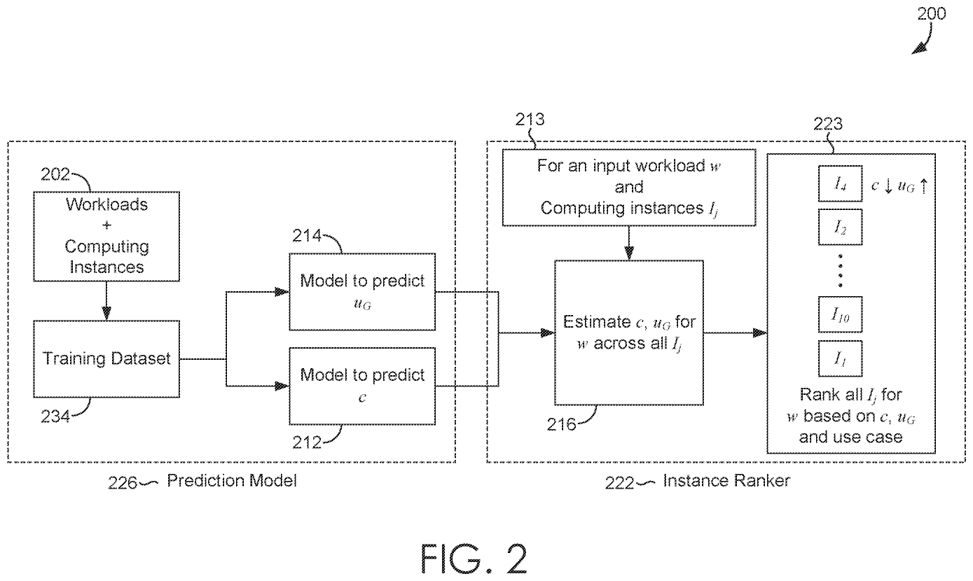

FIG. 2 illustrates an environment 200 in which computing instances are ranked based on metrics predicted by a prediction model 226, in accordance with at least one embodiment. For example, an instance ranker 222 generates a ranking 223 of computing instances based on estimated metrics 216. In an embodiment, the estimated metrics 216 are generated by a prediction model 226 using an input workload w and computing instances Iⱼ 213. Furthermore, in various embodiments, the estimated metrics 216 include epoch training time c 212 and average processor utilization u_{G} 214.

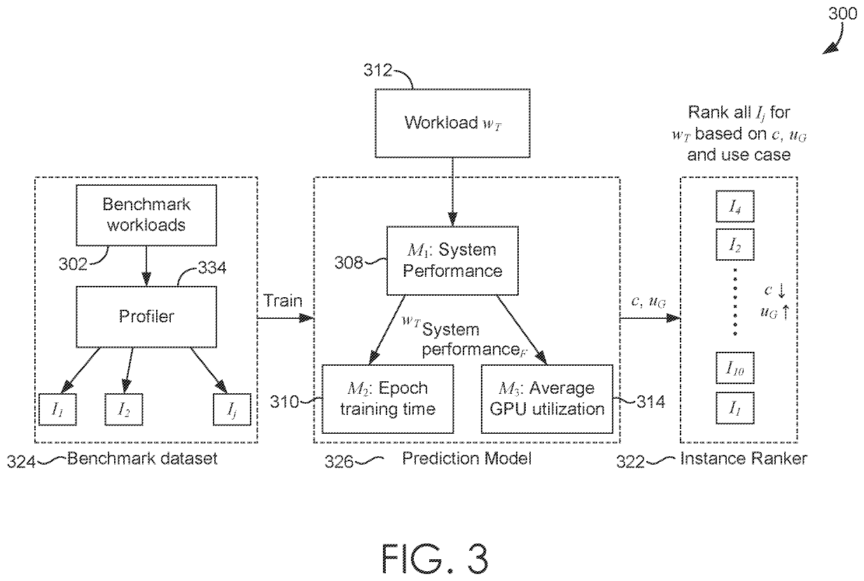

In various embodiments, the prediction model 226 includes a trained regression model to output metrics for a particular input workload w and computing instances Iⱼ 213. As described above, for example, the prediction model 226 performs 3 tasks (e.g., includes three models): system performance metrics prediction, epoch training time c prediction (e.g., which can then be multiplied by the available per-hour computing instance usage costs), and average processor utilization u_{G}. In various embodiments, workload and computing instance data 202 is obtained and used to generate a training data set 234 used to train the prediction model 226. For example, the computing instance data 202 includes hardware metrics such as GPU power usage, GPU core temperature, GPU performance, resource efficiency, storage availability, core temperature, memory bandwidth, cache usage, power usage, memory utilization, processor utilization, and time-series-based utilization values. For example, as described below in connection with FIG. 3, a profiler or other application extracts or otherwise obtains metrics to be included in the training dataset 234.

In various embodiments, when the input workload w and/or computing instance Iⱼ has already been seen during the training phase (e.g., is included in the training dataset), data for the corresponding system performance features (e.g., the set of metrics used by the prediction model 226) is available to use as input for the prediction model 226. However, in other embodiments, when the input workload w and/or computing instance Iⱼ is unseen (e.g., is not included in the training data set), the system performance features need to be generated by the prediction model 226. For example, a feed forward loop is used, where the system performance features are output variables and the static features (e.g., the input workload w and/or computing instance Iⱼ) are input variables.

FIG. 3 illustrates an environment 300 in which computing instances are ranked based on metrics predicted by a prediction model, in accordance with at least one embodiment. In various embodiments, a benchmark dataset 324 is generated and used to train a prediction model 326, which estimates system performance metrics for computing instances, and the estimated system performance metrics are then used by an instance ranker 322 to generate a ranking of instances. For example, the instance ranker 322 ranks computing instance configurations for executing a workload 312. In various embodiments, benchmark workloads 302 are collected by at least causing computing instances to process workloads and obtain metrics data.

In various embodiments, a profiler 334 processes the benchmark workloads 302 to generate the benchmark dataset 324 by at least associating metrics with particular computing instances. In one example, the profiler 334 processes the benchmark workloads 302 to extract various metrics such as GPU Architecture, number of GPUs, number of CPUs, GPU, memory, epoch training time, epoch training cost, GPU utilization, and other features mentioned above.

In various embodiments, the prediction model 326 outputs, as described above, epoch training time c prediction (e.g., which can then multiplied by the available per-hour computing instance usage costs), and average processor utilization u_{G} based on the workload w_{T} and the computing instances Iⱼ. For example, a model M₁ estimates and/or predicts system performance metrics 308 which are provided as inputs to model M₂ and model M₃. Continuing this example, the model M₂ estimates and/or predicts epoch training time and model M₃ estimates and/or predicts average GPU utilization 314. In an embodiment, the instance ranker 322 utilizes the outputs of the prediction model 326 to rank the computing instances Iⱼ. For example, the instance ranker 322 ranks the computing instances based on average GPU utilization, epoch training time, or a combination.

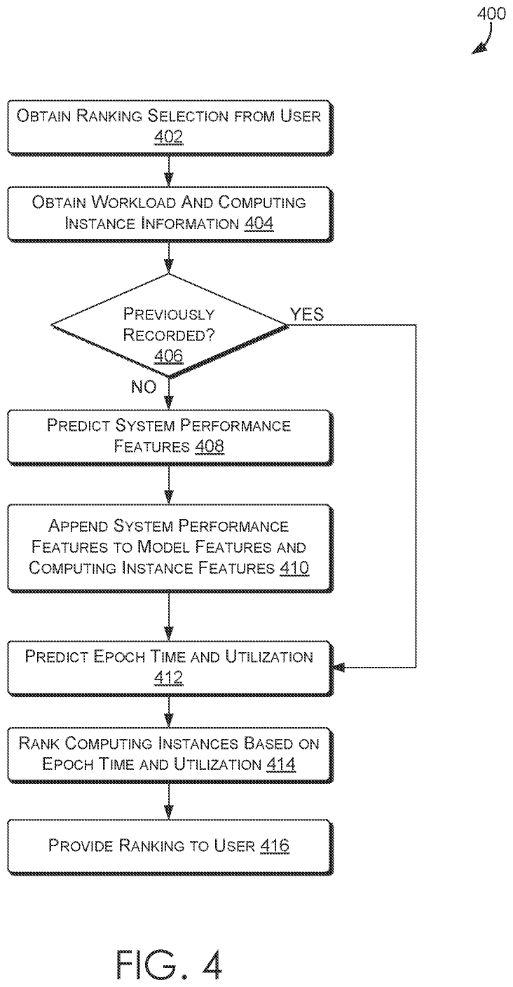

FIG. 4 is a flow diagram showing a method 400 for ranking computing instances based on metrics predicted by a prediction model in accordance with at least one embodiment. The methods 400, 500, and 600 can be performed, for instance, by the instance recommendation tool 104 of FIG. 1. Each block of the methods 400, 500, and 600 and any other methods described herein comprise a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 402, the system implementing the method 400 obtains a ranking selection from a user. As described above in connection with FIG. 1, in various embodiments, the user can select metrics to maximize or minimize for computing instances executing a workload. For example, the user selects a ranking that maximizes GPU utilization and memory utilization while minimizing epoch training time.

At block 404, the system implementing the method 400 obtains workload and computing instance information. For example, the user provides information indicating various attributes of the workload such as model type, number of layers, number of activations, batch size, or other information associated with the workload. In addition, in various embodiments, the system implementing the method 400 obtains computing instance information indicating configuration information for a set of computing instances the user wants to rank. For example, the system implementing the method 400 obtains system architecture information for a set of computing devices that can process the workload.

At block 406, the system implementing the method 400 determines whether the combination of computing instance and workload has been previously recorded. For example, the system implementing the method 400 determines whether the combination is stored in a benchmark dataset used to train a prediction model. In one embodiment, if the combination is previously recorded, the system implementing the method 400 continues to block 412 and predicts the epoch time and utilization for the computing instances processing the workload. However, in other embodiments, if the combination is not previously recorded, the system executing the method 400 continues to block 408 and predicts system performance features.

For example, at block 408, the prediction model predicts system performance metrics for the previously unseen combination of configurations of the computing instance and/or workload. At block 410, the system implementing the method 400 appends the system performance features to model features and computing instance features. For example, as described above, the prediction model includes various class features such as performance metrics, model parameters, and computing instance configurations. At block 412, the system implementing the method 400 predicts epoch time and utilization. In one example, the prediction model takes as an input model features and computing instance features and outputs system performance features (e.g., metrics such as epoch training time and processor utilization).

At block 414, the system implementing the method 400 ranks computing instances based on epoch time and utilization. For example, based on the ranking selected by the user, an instance ranker generates a ranking and/or list of computing instances available to process the workload. At block 416, the system implementing the method 400 provides the ranking to the user. In one example, the ranking is provided to the user through a user interface.

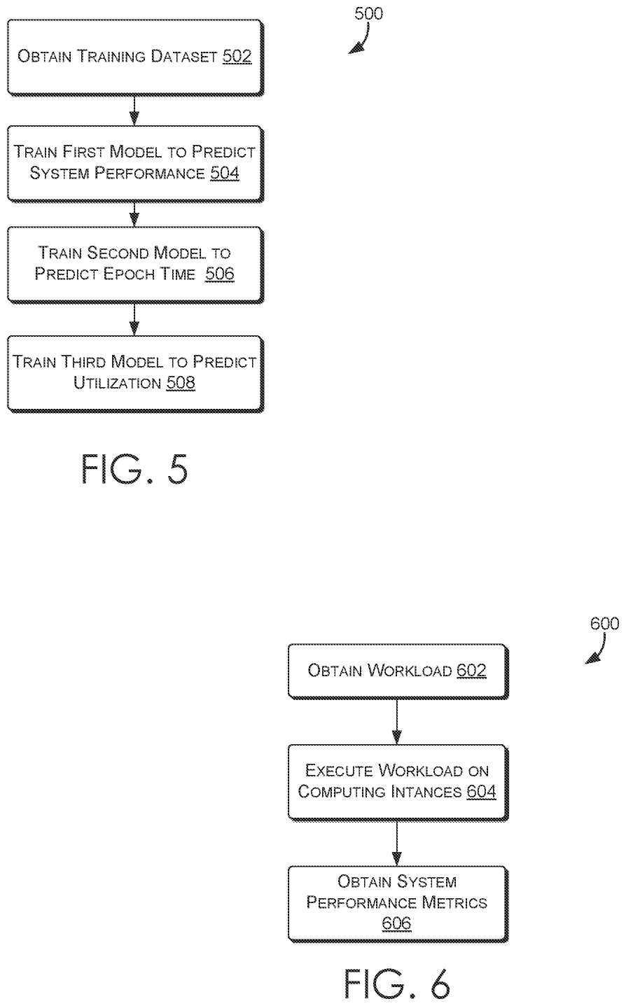

FIG. 5 is a flow diagram showing a method 500 for training a prediction model to predict metrics for a computing instance processing a workload in accordance with at least one embodiment. At block 502, the system implementing the method 500 obtains a training dataset. For example, as described above, metrics are collected from a plurality of computing instances executing a plurality of workloads.

At block 504, the system implementing the method 500 trains a first model to predict system performance. As described above, in one example, a model M₁ is trained using the training data set to estimate and/or predict system performance metrics. In an embodiment, the model M₁ is a regression model. At block 506, the system implementing the method 500 trains a second model to predict epoch time. In an embodiment, as described above, a model M₂ is trained using the training dataset to estimate and/or predict an amount of time to complete one training epoch. In one example, the output of the model M₁ is used to train M₂.

At block 508, the system implementing the method 500 trains a third model to predict utilization. In an embodiment, as described above, a model M₃ is trained using the training dataset to estimate and/or predict processor utilization and/or utilization of other computing hardware. In one example, the output of the model M₁ is used to train M₃.

FIG. 6 is a flow diagram showing a method 600 for generating a training dataset to train a prediction model in accordance with at least one embodiment. At block 602, the system implementing the method 600 obtains a workload. For example, the workload, as described above, includes training data and a model (e.g., layers, activations, parameters, etc.) to train the model. In various embodiments, the system implementing the method 600 obtains a plurality of different workloads with different models and training sets.

At block 604, the system implementing the method 600 executes the workload on computing instances. For example, a plurality of different computing instances are instantiated and used to execute the workload. The computing instance, in an embodiment, includes different configurations such as GPU architecture and number of processors. At block 606, the system implementing the method 600 obtains system performance metrics. For example, the computing instances include an application that collects time-series data during executing of the workload.

Having described embodiments of the present invention, FIG. 7 provides an example of a computing device in which embodiments of the present invention may be employed. Computing device 700 includes bus 710 that directly or indirectly couples the following devices: memory 712, one or more processors 714, one or more presentation components 716, input/output (I/O) ports 718, input/output components 720, and illustrative power supply 722. Bus 710 represents what may be one or more busses (such as an address bus, data bus, or combination thereof). Although the various blocks of FIG. 7 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art and reiterate that the diagram of FIG. 7 is merely illustrative of an exemplary computing device that can be used in connection with one or more embodiments of the present technology. Distinction is not made between such categories as “workstation,” “server,” “laptop,” “handheld device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 700. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 712 includes computer storage media in the form of volatile and/or nonvolatile memory. As depicted, memory 712 includes instructions 724. Instructions 724, when executed by processor(s) 714 are configured to cause the computing device to perform any of the operations described herein, in reference to the above discussed figures, or to implement any program modules described herein. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc. I/O components 720 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 700. Computing device 700 may be equipped with depth cameras, such as stereoscopic camera systems, infrared camera systems, RGB camera systems, and combinations of these, for gesture detection and recognition. Additionally, computing device 700 may be equipped with accelerometers or gyroscopes that enable detection of motion. The output of the accelerometers or gyroscopes may be provided to the display of computing device 700 to render immersive augmented reality or virtual reality.

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).”

What is claimed is:

1. A method comprising:
obtaining an indication of a metric to rank a set of computing instances and a set of workload features of a workload;
causing a machine learning model to determine an epoch training time and a processor utilization for computing instances of the set of computing instances based on the set of workload features of the workload, a set of computing instance features of the set of computing instances, and a set of performance features;
ranking the set of computing instances in accordance with the metric based on the epoch training time and the processor utilization associated with the computing instances of the set of computing instances; and
causing the ranking of the set of computing instances in a user interface.

2. The method of claim 1, wherein the method further comprises causing a second machine learning model to determine the set of performance features based on the set of workload features and the set of computing instance features.

3. The method of claim 2, wherein causing the second machine learning model to determine the set of performance features is in response to the workload or the set of computing instances having not been previously recorded.

4. The method of claim 2, wherein the method further comprises training the machine learning model and the second machine learning model using a training dataset including a set of metrics obtained by at least causing the set of computing instances to execute a set of workloads.

5. The method of claim 1, wherein the set of computing instance features includes at least one of: a number of Graphic Processing Units (GPUs), GPU memory, GPU memory type, GPU type, number of Central Processing Units (CPUs), number of virtual CPUs, CPU type, CPU memory, and CPU memory type.

6. The method of claim 1, wherein the set of performance features includes at least one of: average Graphic Processing Unit (GPU) utilization, minimum GPU utilization, maximum GPU utilization, average Central Processing Unit (CPU) utilization, minimum CPU utilization, maximum CPU utilization, average memory utilization, minimum memory utilization, maximum memory utilization, core temperature, memory bandwidth, cache usage, and power usage.

7. The method of claim 1, wherein the set of workload features includes at least one of: a number of floating point operations (FLOPs), number of layers, number of activations, number of parameters, and batch size.

8. A non-transitory computer-readable medium storing executable instructions embodied thereon, which, when executed by a processing device, cause the processing device to perform operations comprising:
causing a machine learning model to determine a metric associated with a computing instance when executing a workload, the machine learning model taking as inputs a set of workload features associated with the workload, a set of computing instance features associated with a plurality of computing instances, and a set of metrics obtained from the plurality of computing instances during execution of a plurality of workloads;
generating a ranking of a set of computing instances, including the computing instance, based on the metric; and
updating a display to include the ranking of the set of computing instances.

9. The medium of claim 8, wherein the processing device further performs operations comprising causing a second machine learning model to determine at least a portion of the set of metrics.

10. The medium of claim 8, wherein the set of metrics include benchmarks obtained from the plurality of computing instances during execution of the plurality of workloads.

11. The medium of claim 8, wherein the machine learning model is trained using the set of metrics.

12. The medium of claim 8, wherein the ranking of the set of computing instances further comprises an ordering of the set of computing instances from a lowest epoch training time to a highest epoch training time.

13. The medium of claim 8, wherein the ranking of the set of computing instances further comprises an ordering of the set of computing instances from a highest processor utilization to a lowest processor utilization.

14. The medium of claim 8, wherein the machine learning model is a regression model.

15. The medium of claim 8, wherein the processing device further performs operations comprising:
obtaining an indication of the metric to optimize and the workload from a user interface; and
determining the set of workload features based on the workload.

16. A system comprising:
a memory component; and
a processing device coupled to the memory component, the processing device to perform operations comprising:
obtaining a training dataset including benchmark data captured from a plurality of computing instance configurations executing a plurality of workloads;
training a machine learning model to determine system performance features for a set of computing instances based on a set of workload features and the set of computing instances, the machine learning model trained using the training dataset including a set of computing instance features and a set of machine learning model features extracted from the training dataset;
providing the machine learning model to an instance recommendation tool to rank computing instances based on the system performance features; and
causing the instance recommendation tool to rank computing instances based on the system performance features.

17. The system of claim 16, wherein the system performance features include at least one of: average Graphic Processing Unit (GPU) utilization, minimum GPU utilization, maximum GPU utilization, average Central Processing Unit (CPU) utilization, minimum CPU utilization, maximum CPU utilization, average memory utilization, minimum memory utilization, maximum memory utilization, core temperature, memory bandwidth, cache usage, and power usage.

18. The system of claim 16, wherein the set of computing instance features includes at least one of: a number of Graphic Processing Units (GPUs), GPU memory, GPU memory type, GPU type, number of Central Processing Units (CPUs), number of virtual CPUs, CPU type, CPU memory, and CPU memory type.

19. The system of claim 16, wherein the set of machine learning model features includes at least one of: a number of floating point operations (FLOPs), number of layers, number of activations, number of parameters, and batch size.

20. The system of claim 16, wherein the training dataset is generated by at least causing a set of machine learning models corresponding to the set of machine learning model features to executed the plurality of workloads using a plurality of computing instances.
